(19) United States
(12) Patent Application Publication
(10) Pub. No.: US 2006/0292916 A1
(43) Pub. Date: Dec. 28, 2006

(54) Electrical cable connectors, electrical cable assemblies, and methods of making same

(75) Inventors: Nicholas Adam Bundza, Ottawa (CA); Jeffrey Richter, Kanata (CA)

Correspondence Address: Arnold B. Silverman;Eckert Seamans Cherin & Mellot, LLC, 44th Floor, 600 Grant Street, Pittsburgh, PA, 15219, US

(73) Assignee: Alcatel, Paris (FR)

(21) Appl. No.: 11/159,791

(22) Filed: Jun. 23, 2005

(51) Int. Cl. H01R 13/627

(52) U.S. Cl. 439/362

(57) ABSTRACT

Electrical cable connectors, electrical cable assemblies, and methods of making such electrical components are disclosed. An electrical cable connector, illustratively a right-angle connector, has opposite ends and includes both a cable receiving portion and a fastener receiving portion at one end. The cable receiving portion receives an electrical cable and the fastener receiving portion receives a fastener for securing the electrical connector assembly to a mounting structure. The fastener receiving portion also provides access to the fastener. In one embodiment, the fastener receiving portion traverses the cable receiving portion to thereby make the fastener accessible.

### FIELD OF THE INVENTION

This invention relates generally to electrical connectors, and in particular to connectors for electrical cables and electrical cable assemblies including such connectors.

### BACKGROUND

So-called 90° or right-angle connectors are often used in space-limited applications to connect electrical cables to mating connectors. This type of connector has a lower profile than other types of connector such as 180° connectors and 45° connectors.

An electrical cable having a right-angle connector enters one end of the connector, and contacts of the connector are disposed substantially perpendicular to the cable. This arrangement of the cable and contacts provides the low profile feature of a right-angle connector, but can also lead to difficulties in securing the connector to a mating connector. As those skilled in the art will appreciate, 180° connectors and 45° connectors often incorporate captive screws at opposite ends to allow these connectors to be firmly secured to mating connectors. Since a right-angle connector receives an electrical cable at one of its ends, however, it cannot accommodate screws at both its ends.

Typically, a nylon cable tie is used at a cable end of a right-angle connector to fasten the connector to a mating connector, on communication equipment such as a Digital Subscriber Line Access Multiplexer (DSLAM), for example. However, significant field failures with intermittent line continuity have been observed for mating connectors which are secured using cable ties.

Nylon cable ties are prone to incorrect installation, as they tend to be relatively difficult to install properly, and are susceptible to human error and variability. If a cable tie is improperly installed, a connector can lose contact with its mating connector, thus interrupting continuity on a connection.

In addition, cable ties can become loose through handling or shipping, even if they have been properly installed. Loose cable ties are another cause of intermittent connections, as they allow a cable end portion of a connector to become unseated from a mating connector.

Cable ties, over time, may also become loose from material creep and/or become brittle and break, jeopardizing the integrity of a connection.

Most standard equipment and connectors with which right-angle connectors are used provide a pair of threaded apertures or screw lugs for receiving screws to secure both ends of a connector. Accordingly, special clips for receiving cable ties must normally be added to such equipment if right-angle connectors and cable ties are to be used.

Thus, there remains a need for a cable connector which can be more reliably secured to a mounting structure such as a mating connector.

### SUMMARY OF THE INVENTION

An improved electrical cable connector according to one embodiment of the invention includes a connector over-mold which eliminates the need for a nylon cable tie by incorporating a captive screw in a connector area at which a cable enters the connector. In order to accommodate the captive screw at the cable end of the connector, a cable ground shield may be terminated before the captive screw. Where a connector shield is provided, conductive tabs may be used to connect the cable shield to the connector shield.

According to one aspect of the invention, there is provided a housing for an electrical connector assembly. The housing includes a cable receiving portion at an end of the housing for receiving an electrical cable to be coupled to the electrical connector assembly, and a fastener receiving portion for receiving a fastener for securing the electrical connector assembly to a mounting structure, the fastener receiving portion traversing the cable receiving portion.

In one embodiment, the fastener receiving portion includes a through hole.

The housing may be implemented in an electrical connector to cover at least a portion of an electrical connector assembly.

In another embodiment, the housing is implemented in an electrical cable assembly and covers at least a portion of an electrical connector assembly which has one or more contacts electrically connected to respective conductors of an electrical cable.

An electrical connector is also provided, and includes a cable receiving portion at an end of the connector for receiving an electrical cable, and a fastener receiving portion for receiving a fastener for securing the electrical connector assembly to a mounting structure, the fastener receiving portion traversing the cable receiving portion.

The fastener receiving portion may include a sleeve traversing the cable receiving portion.

The connector may also include an electrical connector assembly to be coupled to the electrical cable and a housing covering at least a portion of the electrical connector assembly. In this case, the sleeve may be aligned with through holes of the electrical connector assembly and the housing.

In some embodiments, the fastener comprises a screw, and the sleeve comprises means for retaining the screw.

The connector may include a second fastener receiving portion, at a second end opposite the end of the connector, for receiving a second fastener for securing the connector to the mounting structure.

According to one embodiment, the fasteners are screws, and the mounting structure includes threaded apertures to be respectively engaged by the screws.

The connector may also include an electrical connector assembly to be coupled to the electrical cable, and a shield at least partially enclosing the electrical connector assembly and extending past the fastener receiving portion toward the cable receiving portion. In one embodiment, the shield includes a shielding body and tabs electrically connected to the shielding body. The tabs extend from the shielding body past the fastener receiving portion toward the cable receiving portion.

The connector may be implemented in an electrical cable assembly which includes an electrical cable having one or more conductors. Where the fastener receiving portion comprises a sleeve for receiving the fastener, the one or more conductors are disposed around the sleeve. In a shielded cable assembly, a shielding body of the connector may be electrically connected to a cable shield, which encloses one or more conductors of the cable, through shielding tabs.

According to a further aspect of the invention, there is provided a method of manufacturing an electrical component. The method includes providing an electrical connector assembly and covering at least a portion of the electrical connector assembly with a housing. The housing has, at one end, a cable receiving portion for receiving an electrical cable and a fastener receiving portion for receiving a fastener for securing the electrical connector assembly to a mounting structure. The fastener receiving portion traverses the cable receiving portion.

The method may also include providing an electrical cable and electrically connecting the electrical cable to the electrical connector assembly. Covering may include over-molding the housing on the portion of the electrical connector assembly and a portion of the electrical cable, with the cable receiving portion being formed by over-molding the housing on the portion of the electrical cable.

Where the electrical connector assembly comprises a through hole, the method may include inserting a sleeve into the through hole. When the sleeve is inserted, an interior cavity of the sleeve is aligned with the through hole.

In one embodiment, the electrical cable includes one or more conductors. The operation of electrically connecting the electrical cable to the electrical connector assembly may in this case include arranging the one or more conductors around the sleeve. Over-molding may include over-molding the housing on the sleeve. The interior cavity of the sleeve then forms the fastener receiving portion.

As noted above, an electrical cable may include a cable shield enclosing the one or more conductors. The method may include providing a shielding body covering at least a portion of the electrical connector assembly with the shielding body, and electrically connecting the shielding body to the cable shield. The housing may then be over-molded on the shielding body.

The operation of electrically connecting the shielding body to the cable shield may include providing shielding tabs, electrically connecting the shielding body to the shielding tabs, and electrically connecting the shielding tabs to the cable shield.

Another aspect of the invention provides a right-angle electrical connector having opposite ends. One of the opposite ends of the electrical connector is for receiving an electrical cable, and the electrical connector includes, proximate each of the opposite ends, a respective fastener receiving portion adapted to provide access to a fastener for securing the connector to a mounting structure.

In one embodiment, the one end of the electrical connector includes a cable receiving portion for receiving the electrical cable, and the fastener receiving portion which is proximate the one end traverses the cable receiving portion.

Other aspects and features of the present invention will become apparent to those ordinarily skilled in the art upon review of the following description of specific illustrative embodiments thereof.

### BRIEF DESCRIPTION OF THE DRAWINGS

Examples of embodiments of the invention will now be described in greater detail with reference to the accompanying drawings, in which:

FIG. 1 is a perspective view depicting a shielded cable assembly;

FIG. 2 is a cross sectional view taken along the line 2-2 in FIG. 1;

FIG. 3 is a perspective view of an electrical cable assembly secured to a mounting structure;

FIG. 4 is a plan view of the cable assembly and mounting structure of FIG. 3;

FIG. 5 is a side view of an electrical cable assembly of an embodiment of the invention;

FIG. 6 is a view of a connector assembly of the electrical cable assembly of FIG. 5;

FIG. 7 is an end view of the electrical cable assembly of FIG. 6;

FIG. 8 cross sectional view taken along line 8-8 of FIG. 6;

FIG. 9 is an exploded view of an electrical cable assembly according to an embodiment of the invention;

FIG. 10 is a flow diagram illustrating a method in accordance with another embodiment of the invention;

FIG. 11 is a perspective view of an electrical cable assembly secured to a mounting structure; and

FIG. 12 is a plan view of the electrical cable assembly and mounting structure of FIG. 11.

### DETAILED DESCRIPTION OF PREFERRED EMBODIMENTS

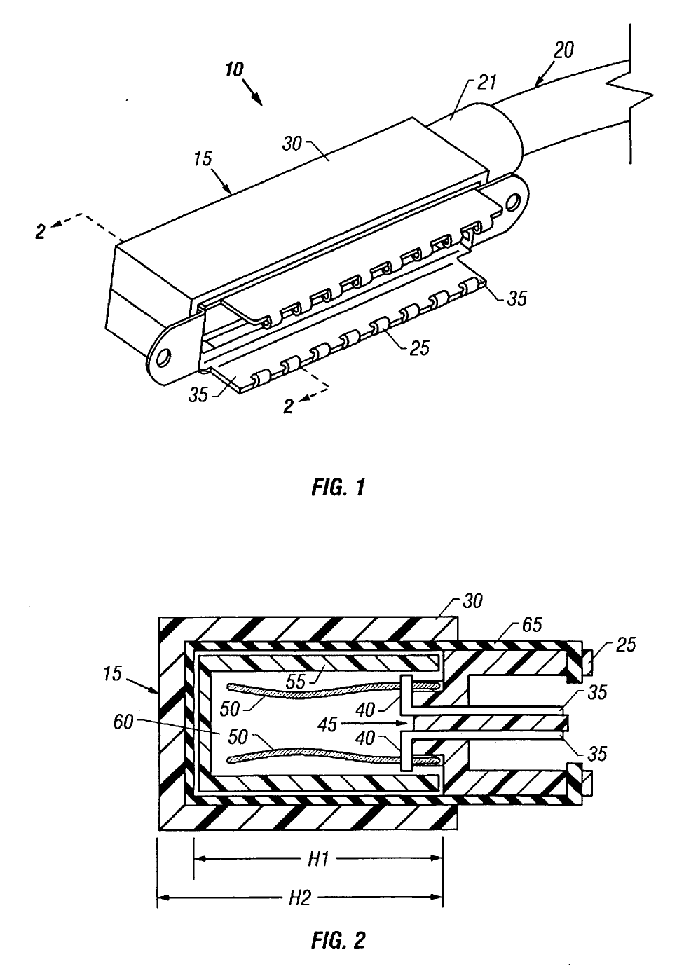

FIG. 1 is a perspective view depicting a shielded cable assembly. The cable assembly 10 includes a connector 15 electrically connected at a first end 21 to an electrical cable 20. The cable 20 may have another connector, such as another connector 15, electrically connected at a second end thereof.

The connector 15 includes a connector assembly 25 and an insulating housing or cover 30 formed thereon. An over-molding operation is one example of a suitable technique for forming the insulating cover 30 on the connector assembly 25. The connector assembly 25 includes a plurality of contacts 35 attached thereto.

As depicted in FIG. 2, which is a cross sectional view taken along the line 2-2 in FIG. 1, each one of the contacts 35 includes a wire attachment portion 40 adjacent to a wire attachment region 45 of the connector assembly 25. The wire attachment portion 40 of at least one of the contact members 35 has an insulated wire 50 attached thereto. An insulation displacement element is an example of the wire attachment portion 40.

The connector 15 includes an insulating insert 55. The wire attachment portion 40 of each one of the contact members 35 and the adjacent portion of each attached insulated wire 50 are positioned in a wire-receiving region 60 of the insulating insert 55. A cavity defined by the insulating insert is an example of the wire-receiving region 55. The insulating insert 55 is preferably made from a non-conductive material such as a polymeric material. Nylon, polyethylene, polypropylene, and polyester are examples of suitable polymeric materials. The insulating insert 55 may be formed using a technique such as injection molding, extrusion, or any other suitable manufacturing technique.

Still referring to FIG. 2, the connector 15 includes a shield 65 for limiting adverse affects of electromagnetic interference (EMI). The shield 65 covers at least a portion of the connector assembly 25 and at least a portion of the insulating insert 55. It is advantageous for the shield 65 to cover a significant portion of the connector assembly 25 and the insulating insert 55. In this manner, the potential for adverse affects associated with EMI is reduced.

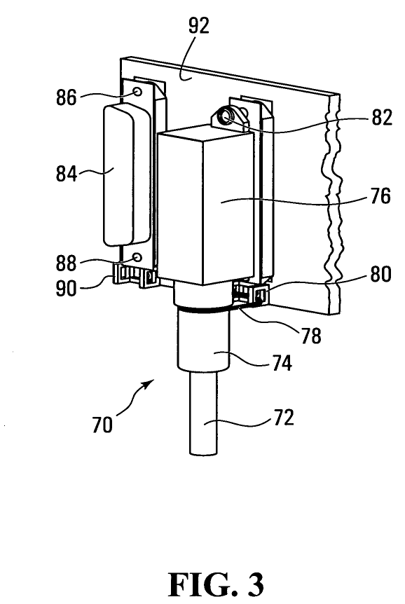

FIG. 3 is a perspective view of an electrical cable assembly, which may be substantially similar to the cable assembly 10, secured to a mounting structure. The cable assembly 70 includes a cable 72, a bead 74, and a connector 76. A cable tie 78 and a screw 82 are provided at opposite ends of the connector 76 to secure the connector 76 to a mounting structure 92.

The mounting structure 92 may be a communication equipment shelf or chassis, for example, which includes multiple connectors 84 for mating with cable connectors such as 76. The mating connectors 84 have apertures 86, 88, typically in the form of threaded through holes or screw lugs, for receiving screws provided in cable connectors. The connector 76, however, receives the cable 72 at one of its ends and therefore can accommodate only a single screw 82. The cable end of the connector 76 is secured to the mounting assembly 92 using a cable tie 78 and a special cable clip 80 which is added to the mounting structure 92. In a typical installation, standard equipment must be modified to attach cable clips 80, 90 to a mounting structure 92.

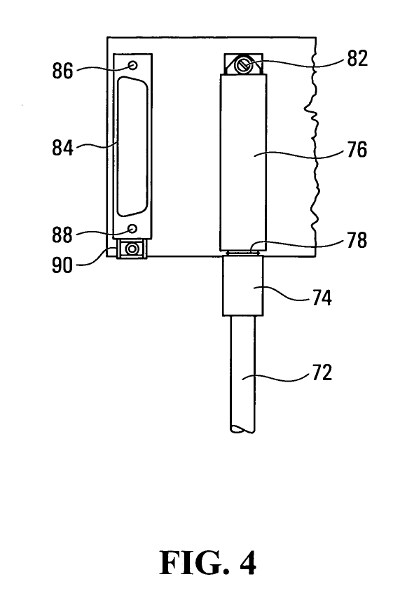

One of the difficulties in properly installing cable ties can be appreciated from a review of FIG. 4, which is a plan view of the cable assembly and mounting structure of FIG. 3. Although a groove is normally provided for the cable tie 78, the cable tie is loose when being installed and can move out of the groove quite easily while being tightened. In this case, if the cable tie shifts to re-enter the groove after it has been installed, it will not hold the connector 76 in place, which may lead to connection continuity problems as noted above.

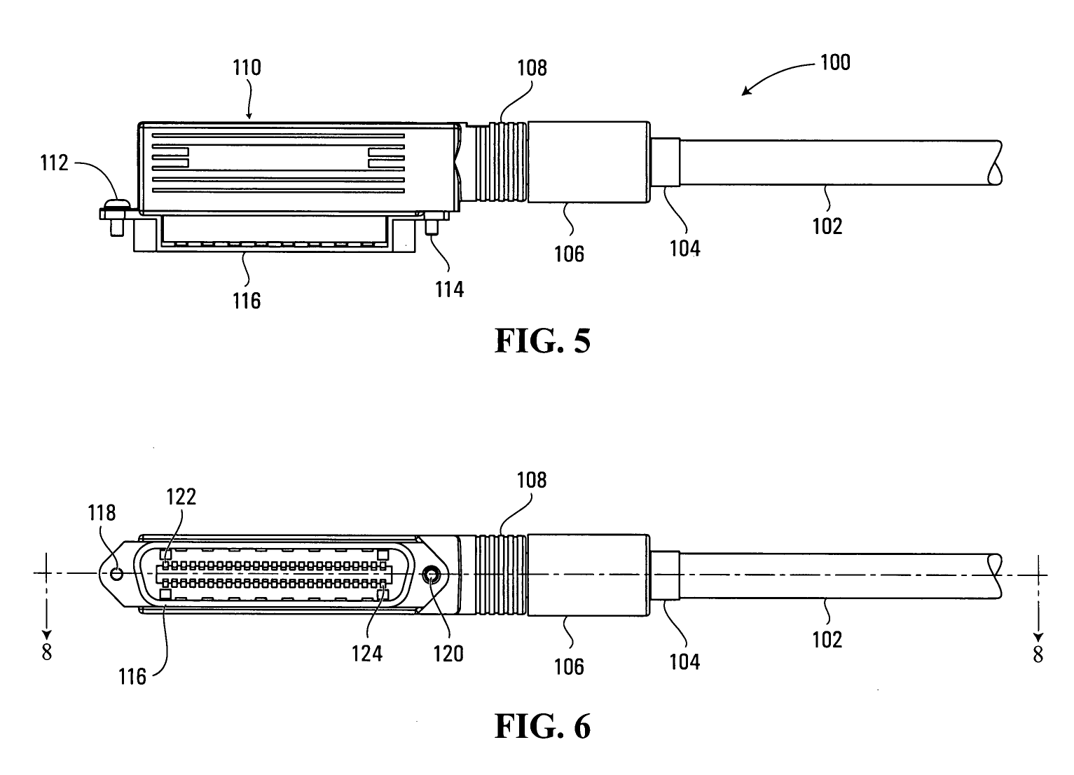

FIG. 5 is a side view of an electrical cable assembly 100 of an embodiment of the invention. The cable assembly 100 includes a cable 102 which is received in a cable receiving portion 108 at an end of a connector 110. A bead 106 is held against the cable receiving portion of the connector 110 by a heatshrink 104.

In accordance with an aspect of the invention, the connector 110 includes a fastener receiving portion at its cable end, proximate the cable receiving portion 108, for receiving a fastener. The fastener is used to secure the connector 110, or at least the connector assembly 116, to a mounting structure. One example of a fastener which may be received by the fastener receiving portion of the connector 110 is a screw 114.

An end of the connector 110 opposite the cable end may also be secured to a mating connector or other mounting structure using a screw 112. The screws 112, 114 may be captive screws and/or provided separately from the cable assembly 100 and installed when the connector 110 is to be secured to a mounting structure.

A connector assembly 116 of the connector 110 can thereby be more firmly secured to a mating connector, for example, using screws 112, 114 at its opposite ends. The screw 114 eliminates the need for a cable tie at the cable end of the connector 110.

The connector 110, in one embodiment, thus forms a right-angle electrical connector having opposite ends, with one of the opposite ends receiving the electrical cable 102, and each of its end having respective fastener receiving portions adapted to accommodate fasteners for securing the connector to a mounting structure.

FIG. 6 is a view of the connector assembly 116 of the electrical cable assembly of FIG. 5, and illustrates an example connector assembly which may be used in an embodiment of the invention.

The connector assembly 116 includes through holes 118, 120, which in the embodiment shown in FIG. 6 are formed in connector assembly end flanges or extensions. The connector assembly 116 may be a standard type of connector having through holes for alignment with screw lugs or other threaded apertures in a mounting structure. The through holes allow the screws 112, 114 to engage the threaded apertures to thereby secure the connector assembly 116, and thus the connector 110, to the mounting structure.

The connector assembly 116 also includes fifty electrical contacts, two of which are labelled 122, 124, for connection to electrical conductors in the electrical cable 102. These contacts may be of the type shown in FIG. 1, for example. In Telco-50 or RJ-21 connectors, contacts 122, 124 represent pins 1 and 50, respectively.

Other numbers and types of contact may be provided in a connector assembly. The present invention is in no way limited to any particular type of connector assembly or number of contacts. In general, a connector assembly includes electrical contacts to be connected to conductors, illustratively insulated wires, of an electrical cable.

However, connections between contacts and conductors need not necessarily be exclusive. For example, in some implementations, multiple contacts may be connected to the same conductor. Similarly, there may be conductors in an electrical cable which are not connected to a contact in a connector assembly. The number of contacts in a connector assembly also need not necessarily be the same as the number of conductors in an electrical cable.

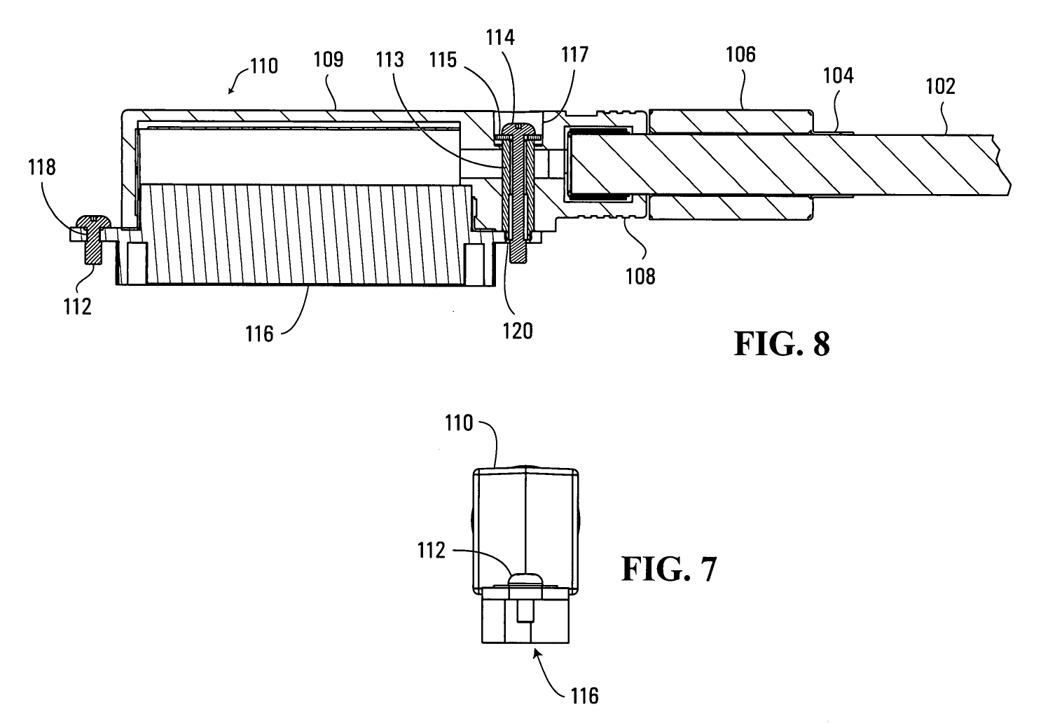

FIG. 7 is an end view of the electrical cable assembly of FIG. 6, and illustrates the end of the connector 110 opposite the cable receiving portion 108.

The physical size of the cable assembly 100 and the connector 110 may vary for different applications which have different constraints. According to one embodiment, the connector 110 has an overall length of approximately four inches, from the screw receiving portion which receives the screw 112 to the end of the cable receiving portion 108, a width of approximate three-quarters of an inch, and an overall height, perhaps shown most clearly in FIG. 7, of less than approximately 1.4 inches.

These dimensions are intended solely for illustrative purposes, and the present invention is in no way limited to any particular dimensions or form factor. Less restrictive applications may permit the use of larger connectors, whereas a cable assembly for a particularly constrained operating environment with little available physical space may be somewhat smaller. To some extent, the size of a connector may also be dependent upon the size of the electrical cable 102, the number of conductors in the electrical cable 102, or both.

FIG. 8 cross sectional view taken along line 8-8 of FIG. 6. The cross sectional view of FIG. 8 illustrates several further features of embodiments of the invention.

In particular, FIG. 8 shows a sleeve 113 and a through hole 117 in a housing 109 of the connector 110 as one embodiment of a fastener receiving portion for receiving a fastener, in this case the screw 114. The sleeve 113 traverses the cable receiving portion 108 of the connector 110, and is aligned with the through hole 117 and the through hole 120 of the connector assembly 116 to permit the screw 114 to pass through the cable receiving portion 108 and engage a mounting structure. The sleeve 113 is preferably integrated with or attached to the connector 110, by over-molding the connector housing 109 over the connector assembly 116 and the sleeve 113 for instance.

A washer 115 seats on an end face of the sleeve 113 when the screw 114 engages a threaded aperture on a mounting structure to thereby secure the connector 110 to the mounting structure. In other embodiments, the washer 115 may also or instead be seated on a countersunk portion of the through hole 117 to secure the housing 109 of the connector 110 to a mounting structure. Having the washer 115 seat on a end face of the sleeve 113, however, may generally be preferred to protect against damage to the housing 109 if the screw 114 is over-tightened.

Means may be provided in the sleeve 113, on the screw 114, or both, for retaining the screw 114 in the sleeve 113. In one embodiment, the sleeve 113 is threaded and the screw is partially threaded to provide a captive screw arrangement.

Since the sleeve 113 passes through the cable receiving portion 108 of the connector 110, it is preferably made of an electrically insulating material. One advantage of using the sleeve 113 to allow the screw 114 to traverse the cable receiving portion 108 is that it maintains an open passageway across the cable receiving portion 108. The cable 102 or its conductors may be arranged around the sleeve 113 during assembly of the connector 110, and the sleeve 113 prevents the cable 102 or conductors from shifting to a position between the through holes 117, 120. The sleeve 113 also protects the cable 102 and its conductors from threads of the screw 114.

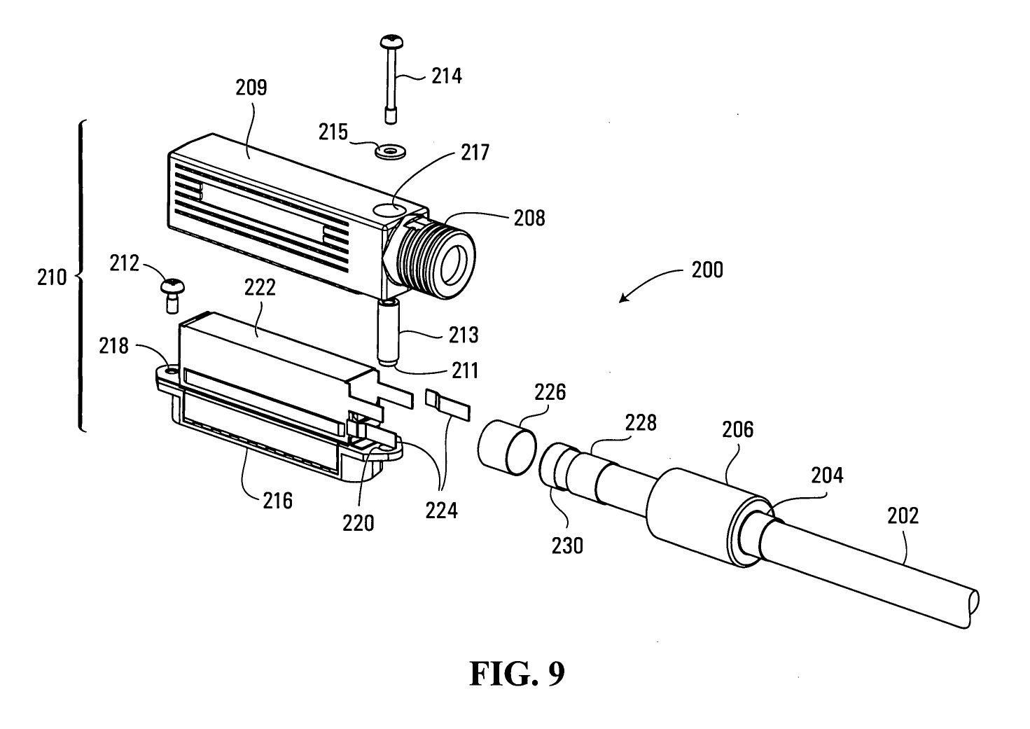

FIG. 9 is an exploded view of an electrical cable assembly according to an embodiment of the invention. The electrical cable assembly 200 includes an electrical cable 202 and a connector 210 comprising a connector assembly 216 and a connector housing 209 which at least partially covers the connector assembly 216. The connector housing 209 includes a cable receiving portion 208 and a through hole 217 which partially forms a screw receiving portion for receiving the screw 214 and the washer 215. A second screw is received at the other end of the connector 210, in a through hole 218 of the connector assembly 216.

A sleeve 213 is also provided, and aligns with the through hole 217 and a through hole 220 in the connector assembly 216. An interior cavity of the sleeve 213 allows the screw 214 to pass from the through hole 217, through the cable receiving portion 208 of the housing 209 and the through hole 120, to engage a mounting structure.

In the cable assembly 200, the connector 210 is a shielded connector with an EMI shield. The shield includes a main shielding body 222 which at least partially encloses the electrical connector assembly 216 and has an open end for receiving the cable 202 or its conductors (not shown). Extension tabs 224, when electrically connected to the shielding body 222, effectively extend the shield past the sleeve 213 toward the cable 202.

In one embodiment, the shielding body 222 is part of a connector assembly kit, and the tabs 224 are added to the shielding body 222 to extend EMI shielding toward the cable 202. However, it should be appreciated that a shielding body may itself extend past the sleeve 213, in which case extension tabs 224 would not be used.

Extending a shield past the sleeve 213 allows the cable 202, or more specifically an outer sheath of the cable 202, to be terminated before the sleeve 213. Termination of the cable 202 at a point outside the sleeve 213 allows conductors of the cable 202 to be arranged around the sleeve 213 to accommodate the sleeve 213 in the cable receiving portion 208 of the connector housing 209. With a shield which extends toward the cable 202 past the sleeve 213, conductors of the cable 202 can be shielded after the cable termination point.

In some embodiments, it may be possible to dispose the entire cable 202 around the sleeve 213 without terminating the cable 202 outside the sleeve 213. The sleeve 213 might be positioned to one side of a cable receiving portion of a connector, for example. In this case, the cable can be terminated inside the shielding body 222.

A cable ground shield is shown at 230 in FIG. 9. The cable shield 230 is preferably electrically connected to the connector shield 222 so that internal conductors of the cable 202 remain shielded once the cable sheath is terminated. The ferrules 226, 228 represent one example of components which may be used to electrically connect a cable shield to a connector shield. In the embodiment shown in FIG. 9, the cable shield 230 is folded back over the inner ferrule 228, the tabs 224 are placed over the cable shield 230, and the outer ferrule 226 is crimped over the tabs 224, the cable shield 230, and the inner ferrule 228.

The bead 206, illustratively a ferrite bead, also provides EMI shielding for embodiments of the invention implemented in shielded cable assemblies. It should be appreciated, however, that shielding components such as the shielding body 222, the tabs 224, and the bead 206, as well as the bead 106 in FIGS. 5-8, need not be provided in all embodiments. A cable assembly would not be shielded, for example, in applications where EMI is not of concern.

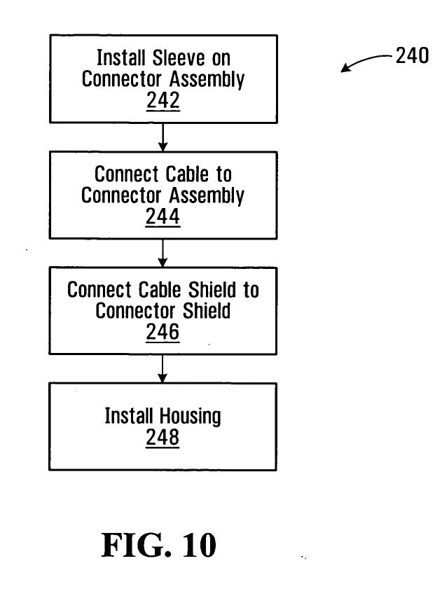

FIG. 10 illustrates a method of manufacturing the cable assembly 200, and other components such as a housing and a connector, in accordance with a further aspect of the invention. The method 240 will be described below with reference to FIGS. 9 and 10.

The method 240 begins at 242 with installing the sleeve 213 in the through hole 220 of the connector assembly 216. The through hole 220 may be provided in the connector assembly or formed in the connector assembly prior to installing the sleeve 213. In some embodiments, the connector assembly 216 is a commercially available connector assembly in which the hole 220 is designed to accommodate a screw having a predetermined diameter. Where a screw of the same diameter is to be used with the sleeve 213, an interior diameter of the sleeve 213 is sufficient to accommodate the screw, and the operation at 242 may involve drilling out or otherwise increasing the size of the hole 220 to receive the sleeve 213. The sleeve 213, which might be a commercially available part such as a threaded standoff, may also or instead include or be modified to include a reduced-diameter portion 211 for insertion into the through hole 220.

The sleeve 213 may be attached to the connector assembly 216 by a friction fit or using an adhesive, for example. According to one embodiment, the sleeve 213 is a self-clinching standoff having serrations, on the outer surface of the portion 211, which hold the sleeve 213 in place when inserted into the through hole 220.

Other ways of attaching the sleeve 213 to the connector assembly 213 may also be used. The sleeve may be attached to a surface of the connector assembly 216 instead of being inserted into the through hole 220, or provided as part of a connector assembly, for example. It is also contemplated that a sleeve may be integrated with a connector housing, or even an electrical cable, instead of being provided as a separate part.

At 244, the electrical cable 202 is connected to the connector assembly 216. As described above, this involves connecting one or more conductors of the cable 202 to contacts of the connector assembly 216. During the operation 244, the cable 202 or its conductors are arranged around the sleeve 213.

For a shielded cable assembly, a cable shield is connected to a connector shield at 246. In the cable assembly 200, this would involve connecting the cable shield 230 to the shielding body 222 through the tabs 224. According to one embodiment, the tabs 224 are welded or otherwise connected to the shielding body 222, and then connected to the cable shield 230 by crimping the outer ferrule 226 over the tabs 224, the cable shield 230, and the inner ferrule 228.

When internal electrical connections have been made, at 244, 246, at least a portion of the electrical connector assembly 216 is covered by installing the housing 209 at 248. The housing 209, as described above, has a cable receiving portion 208 for receiving an electrical cable and a fastener receiving portion, including the through hole 217, for receiving a fastener such as the screw 214 and allowing the fastener to traverse the cable receiving portion 208.

The connector housing 209 may be a separate pre-formed component which is installed over the connector assembly 216 and the cable 202. When fabricated as a two-piece component, for example, the pieces of the housing 209 may be positioned to enclose at least a portion of the connector assembly 216 and the cable 202. The housing pieces are then attached to each other using an adhesive for instance.

Another technique for covering at least portions of the connector assembly 216 and the cable 202 involves over-molding the housing 208 on the connector assembly and the cable. Over-molding the housing 208 on the cable 202 forms the cable receiving portion 208. Over-molding the housing on the sleeve 213 similarly forms a fastener receiving portion, in that the housing 209 is molded around the sleeve 213 while the interior cavity of the sleeve 213 remains open between the through holes 217 and 220.

It should be appreciated that the method 240 represents an illustrative example of one possible embodiment of the present invention. Other embodiments may be implemented with further, fewer, or different operations performed in a similar or different order than explicitly shown.

For example, a cable shield may be connected to a connector shield at 246 before the cable is connected to the connector assembly at 244. In this case, the connector shield is attached or otherwise positioned on the connector assembly 216 to cover at least a portion of the connector assembly 216 after connections to contacts have been made.

An operation which may subsequently be performed but has not been explicitly shown in FIG. 10 is the positioning of the bead 206 at the cable receiving portion 208 of the housing 209 and attachment of the bead to the cable 202 using the heatshrink 204.

Further variations of the method 240 may also be made without departing from the present invention.

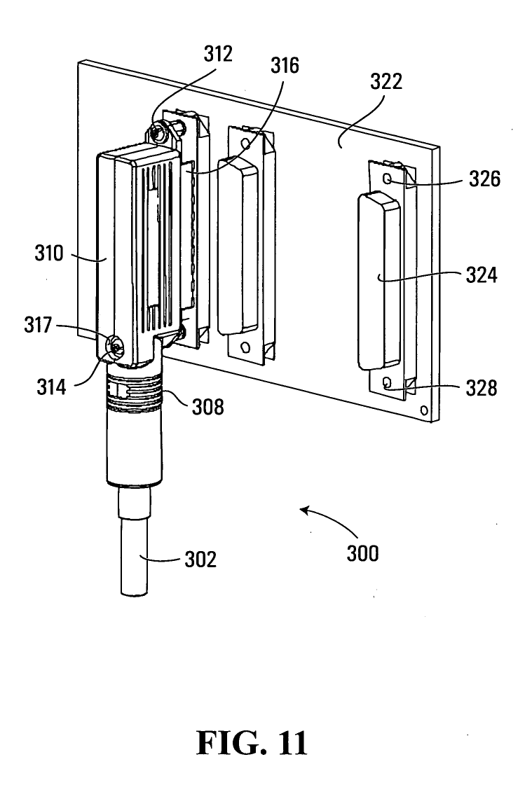

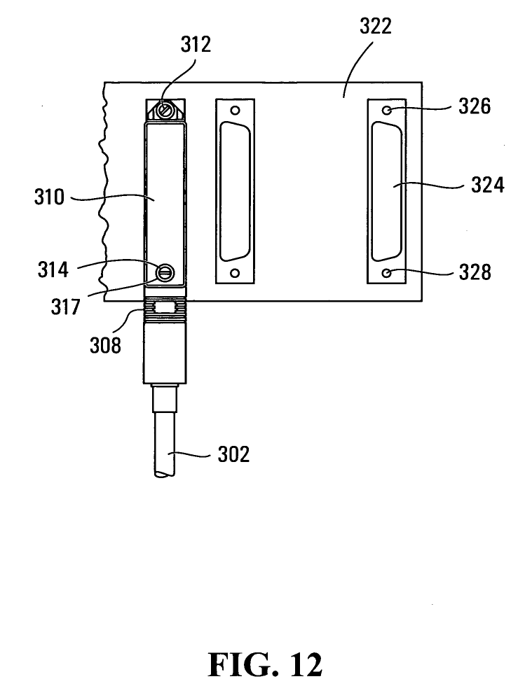

FIGS. 11 and 12 are perspective and plan views, respectively, of an electrical cable assembly 300 according to an embodiment of the invention. In FIGS. 11 and 12, the connector 310 of the cable assembly 300 is secured to a mounting structure 322.

The mounting structure 322 includes mating connectors 324 having threaded apertures 326, 328 to be respectively engaged by the screws 312, 314. As described above, a cable receiving portion 308 of the connector 310 receives an electrical cable 302, and the screw 314 is received in a screw receiving portion, represented by the through hole 317, of the connector 310.

The screws 312, 314 firmly secure the connector assembly 316 of the connector 310 to the mounting structure 322 and thus to a mating connector 324. Intermittent connection problems associated with using cable ties are less likely to occur when using a connector such as 310 which is secured by a pair of fasteners at opposite ends of the connector.

By appropriately spacing the screws 312, 314, the connector 310 can be made compatible with standard mating connectors and other types of mounting structure. With reference to FIGS. 3 and 4, for example, positioning screw receiving portions of a connector to allow screws to engage the threaded apertures 86, 88 which are normally provided in mating connectors 84 allows a connector of an embodiment of the present invention to be used with a mounting structure which had been previously modified to add cable tie clips 80, 90. This provides for backward compatibility of new connectors, connector housings, and cable assemblies with older equipment and legacy systems.

Embodiments of the present invention as disclosed herein provide a simple and cost effective solution to intermittent connection continuity problems which are often experienced due to improperly or unreliably secured connectors. Robust Plain Old Telephone Service to Asymmetric DSL (POTS/ADSL) connections, for example, may be provided by implementing cable assemblies or connectors according to embodiments of the invention at DSLAMs, although the present invention is applicable to other types of connectors and connections.

What has been described is merely illustrative of the application of principles of embodiments of the invention. Other arrangements and methods can be implemented by those skilled in the art without departing from the scope of the present invention.

For example, screws have been described above and shown in the drawings as one illustrative embodiment of a fastener which may be used to secure a connector to a mounting structure. The present invention is not limited to use only with screws. Other types of fastener may be used. A mounting structure might incorporate threaded studs instance, in which case a fastener receiving portion of a connector allows a stud to traverse a cable receiving portion of the connector. A nut may then be used to engage the stud and thereby secure the connector in position.

The invention is similarly not limited to any particular size or shape of housing, connector, or components. Although a cylindrical sleeve has been shown in FIG. 9, for example, other shapes of sleeve may be used in other embodiments.

The sleeve itself is an example of one possible component which may be used to provide a fastener receiving portion of a connector. A passageway through a cable end of a connector might instead be provided by using a temporary stud instead of the sleeve. Once a connector cover is molded over the connector assembly, the temporary stud is removed to allow insertion of a screw or other fastener into a through hole in the connector assembly. A sleeve may be preferred, however, to ensure that a fastener receiving portion does not become blocked in the event that a cable or its conductors shift, and also to protect the cable and conductors from being damaged by the fastener.

In the embodiments of the invention described above, a fastener receiving portion of a connector traverses a cable receiving portion of the connector. However, it is also possible to offset a cable receiving portion at a cable end of a connector so as to accommodate both a fastener and a cable at an end of a connector. In this case, the fastener receiving portion is proximate, but does not necessarily traverse, the cable receiving portion.

A fastener receiving portion may thus provide access to a fastener for securing an electrical connector to a mounting structure. In some embodiments, this access is provided by passing a screw through one end of a connector such that the screw head is disposed in a countersink in a face of a connector housing. A fastener may otherwise be made accessible, such as by offsetting a cable receiving portion and a fastener receiving portion as described above. Another possible access arrangement would be to provide sufficient space to allow a screwdriver other fastener tool to be used to adjust a fastener which would not normally be accessible. With reference to FIG. 8, for example, the entire through hole 117 could be sized to accommodate a head of the screw 114 such that the screw head or the washer 115 seats on the connector assembly 116, in which case a shorter screw could be used. In this case, the through hole 117 is also preferably sized to accommodate a screwdriver for adjusting the screw.

We claim:

1. A housing for an electrical connector assembly, the housing comprising:
a cable receiving portion at an end of the housing for receiving an electrical cable to be coupled to the electrical connector assembly; and
a fastener receiving portion for receiving a fastener for securing the electrical connector assembly to a mounting structure, the fastener receiving portion traversing the cable receiving portion.

2. The housing of claim 1, wherein the fastener receiving portion comprises a through hole.

3. An electrical connector comprising:
an electrical connector assembly; and
the housing of claim 1 covering at least a portion of the electrical connector assembly.

4. An electrical cable assembly comprising:
an electrical cable comprising one or more conductors;
an electrical connector assembly comprising one or more contacts electrically connected to respective conductors of the electrical cable; and
the housing of claim 1 covering at least a portion of the electrical connector assembly.

5. An electrical connector comprising:
a cable receiving portion at an end of the connector for receiving an electrical cable; and
a fastener receiving portion for receiving a fastener for securing the electrical connector assembly to a mounting structure, the fastener receiving portion traversing the cable receiving portion.

6. The connector of claim 5, wherein the fastener receiving portion comprises a sleeve traversing the cable receiving portion.

7. The connector of claim 6, further comprising:
an electrical connector assembly to be coupled to the electrical cable and comprising a through hole; and
a housing covering at least a portion of the electrical connector assembly and comprising a through hole,
wherein the sleeve is aligned with the through holes of the electrical connector assembly and the housing.

8. The connector of claim 6, wherein the fastener comprises a screw, and wherein the sleeve comprises means for retaining the screw.

9. The connector of claim 5, further comprising:
a second fastener receiving portion, at a second end opposite the end of the connector, for receiving a second fastener for securing the connector to the mounting structure.

10. The connector of claim 9, wherein the fasteners comprise screws, and wherein the mounting structure comprises threaded apertures to be respectively engaged by the screws.

11. The connector of claim 5, further comprising:
an electrical connector assembly to be coupled to the electrical cable; and
a shield at least partially enclosing the electrical connector assembly and extending past the fastener receiving portion toward the cable receiving portion.

12. The connector of claim 11, wherein the shield comprises a shielding body and tabs electrically connected to the shielding body, the tabs extending from the shielding body past the fastener receiving portion toward the cable receiving portion.

13. An electrical cable assembly comprising:
an electrical cable comprising one or more conductors; and
the connector of claim 5.

14. The electrical cable assembly of claim 13, wherein the fastener receiving portion comprises a sleeve for receiving the fastener, and wherein the one or more conductors are disposed around the sleeve.

15. The electrical cable assembly of claim 13, further comprising:
an electrical connector assembly comprising one or more contacts electrically connected to respective conductors of the electrical cable;
a shielding body at least partially enclosing the electrical connector assembly; and
shielding tabs electrically connected to the shielding body and extending from the shielding body past the fastener receiving portion toward the cable receiving portion,
wherein the electrical cable further comprises a cable shield enclosing the one or more conductors, and wherein the cable shield is electrically connected to the shielding tabs.

16. A method of manufacturing an electrical component, the method comprising:
providing an electrical connector assembly;
covering at least a portion of the electrical connector assembly with a housing having a cable receiving portion at an end of the housing for receiving an electrical cable and a fastener receiving portion for receiving a fastener for securing the electrical connector assembly to a mounting structure, the fastener receiving portion traversing the cable receiving portion.

17. The method of claim 16, further comprising:
providing an electrical cable; and
electrically connecting the electrical cable to the electrical connector assembly,
wherein covering comprises over-molding the housing on the portion of the electrical connector assembly and a portion of the electrical cable, the cable receiving portion being formed by over-molding the housing on the portion of the electrical cable.

18. The method of claim 17, wherein the electrical connector assembly comprises a through hole, and wherein the electrical cable comprises one or more conductors, the method further comprising:
inserting a sleeve into the through hole, an interior cavity of the sleeve when inserted being aligned with the through hole,
wherein electrically connecting the electrical cable to the electrical connector assembly comprises arranging the one or more conductors around the sleeve, and
wherein over-molding further comprises over-molding the housing on the sleeve, the interior cavity of the sleeve comprising the fastener receiving portion.

19. The method of claim 17, wherein the electrical cable comprises one or more conductors and a cable shield enclosing the one or more conductors, the method further comprising:
providing a shielding body;
covering at least a portion of the electrical connector assembly with the shielding body; and
electrically connecting the shielding body to the cable shield,
wherein over-molding comprises over-molding the housing on the shielding body.

20. The method of claim 19, wherein electrically connecting the shielding body to the cable shield comprises:
providing shielding tabs;
electrically connecting the shielding body to the shielding tabs; and
electrically connecting the shielding tabs to the cable shield.

21. A right-angle electrical connector having opposite ends, one of the opposite ends for receiving an electrical cable, the electrical connector comprising, proximate each of the opposite ends, a respective fastener receiving portion adapted to provide access to a fastener for securing the connector to a mounting structure.

22. The electrical connector of claim 21, wherein the one end of the electrical connector comprises a cable receiving portion for receiving the electrical cable, and wherein the fastener receiving portion proximate the one end traverses the cable receiving portion.
